(19) United States
(12) Patent Application Publication
(10) Pub. No.: US 2017/0207482 A1
(43) Pub. Date: Jul. 20, 2017

(54) METHOD FOR MANUFACTURING ALL-SOLID-STATE BATTERY

(71) Applicant: Toyota Jidosha Kabushiki Kaisha, Toyota-shi Aichi-ken (JP)

(72) Inventors: Seiji Tomura, Susono-shi (JP); Takashi Takemoto, Susono-shi (JP); Tomoya Suzuki, Seto-shi (JP); Kengo Haga, Susono-shi (JP)

(21) Appl. No.: 15/397,257

(22) Filed: Jan. 3, 2017

(30) Foreign Application Priority Data
Jan. 18, 2016 (JP) 2016-007333

(51) Int. Cl. H01M 10/04; H01M 10/0562; H01M 4/58; H01M 4/587; H01M 4/525; H01M 4/38; H01M 4/40; H01M 10/0525; H01M 4/505

(52) U.S. Cl. CPC H01M 10/0468; H01M 10/0525; H01M 10/0562; H01M 4/5825; H01M 4/505; H01M 4/525; H01M 4/382; H01M 4/405; H01M 4/587; H01M 2300/0068

(57) ABSTRACT

Provided is a method for manufacturing an all-solid-state battery with which an all-solid-state battery of high performance may be easily manufactured. The method includes forming a first active material layer on each of a right face and a reverse face of a first current collector, forming a solid electrolyte layer on each first active material layer formed in the forming, arranging a second active material layer arranged on a base material, onto each solid electrolyte layer formed in the forming, in a manner that the solid electrolyte layer and the second active material layer have contact with each other, forming a stack by removing each base material having contact with the second active material layer, carrying out a roll press on the stack, and arranging a second current collector on each second active material layer of the stack on which the roll press is carried out.

### TECHNICAL FIELD

The present disclosure relates to methods for manufacturing all-solid-state batteries.

### BACKGROUND

A metal ion secondary battery provided with a solid electrolyte layer including a solid electrolyte (e.g. lithium ion secondary battery. Hereinafter it may be referred to as “all-solid-state battery”) has advantages, for example the system for securing safety is easily simplified.

As a technique related to such an all-solid-state battery, for example Patent Literature 1 discloses a method for manufacturing an all-solid-state battery including pressing a stack including a second current collector, a second electrode active material layer, a solid electrolyte layer, a first electrode active material layer, a first current collector, a first electrode active material layer, a solid electrolyte layer, a second electrode active material layer, and a second current collector, in the order mentioned.

In the paragraph 0070 in the description of Patent Literature 2 which discloses a method for manufacturing an all-solid-state battery, described is that a cathode layer and an anode layer may be formed and provided on a base material layer. The paragraph 0074 describes that the base material may be removed in manufacturing.

Patent Literature 3 discloses a non-aqueous secondary battery including a cathode, an anode, and a non-aqueous electrolyte solution, wherein at least either one of the cathode and the anode includes an electrode mixture including an electrode active material, a current collector keeping the electrode mixture, and an conductive layer interposed between the current collector and the electrode mixture, and the conductive layer includes a conductive material and polyvinylidene fluoride as a binder.

### CITATION LIST

### Patent Literatures

Patent Literature 1: JP 2015-125872 A
Patent Literature 2: JP 2014-127463 A
Patent Literature 3: JP 2012-104422 A

### SUMMARY

### Technical Problem

When a roll press is carried out on the stack including the first and second current collectors which are different from each other in structural material, as disclosed in Patent Literature 1, a shear force originated from the difference in elongation percentage between the first and second current collectors is generated. The generation of the shear force in a roll press might produce cracks in the first electrode active material layer, the solid electrolyte layer, and the second active material layer. If the crack in the solid electrolyte layer is large, a short circuit occurs and the battery does not function as a battery. That is, by the technique disclosed in Patent Literature 1, it might be difficult to manufacture a high-performance all-solid-state battery. This problem is difficult to be solved even though the technique disclosed in Patent Literature 1 and the techniques disclosed in Patent Literatures 2 and 3 are combined.

An object of the present disclosure is to provide a method for manufacturing an all-solid-state battery with which a high-performance all-solid-state battery can be easily manufactured.

### Solution to Problem

As a result of intensive researches, the inventors of the present disclosure found it is possible to inhibit the cracking in roll press, by manufacturing an all-solid-state batter by carrying out a roll press on a stack including the first current collector, before stacking the second current collector thereon, and after the roll press, arranging the second current collector. The present disclosure has been made based on the above finding.

In order to solve the above problem, the present disclosure is directed to the following embodiments. That is, the present disclosure is a method for manufacturing an all-solid-state battery including: forming a first active material layer on each of a right face and a reverse face of a first current collector; forming a solid electrolyte layer on each said first active material layer formed in the forming; arranging a second active material layer arranged on a base material, onto each said solid electrolyte layer formed in the forming, in a manner that the solid electrolyte layer and the second active material layer have contact with each other; forming a stack by removing each said base material having contact with the second active material layer; carrying out a roll press on the stack; and arranging a second current collector on each said second active material layer of the stack on which the roll press is carried out.

In the present disclosure, the first current collector is an anode current collector or a cathode current collector, and the second current collector is a current collector of different pole from the first current collector. That is, if the first current collector is an anode current collector, the second current collector is a cathode current collector, and if the first current collector is a cathode current collector, the second current collector is an anode current collector. If the first current collector is an anode current collector, the first active material layer is an anode active material layer, and if the first current collector is a cathode current collector, the first active material layer is a cathode active material layer. If the second current collector is a cathode current collector, the second active material layer is a cathode active material layer, and if the second current collector is an anode current collector, the second active material layer is an anode active material layer.

In the present disclosure, after the roll press is carried out, the second current collector is arranged on the second active material layer of the roll pressed stack. By having this configuration, it is possible to prevent the situation in which the roll press is carried out on a stack including two different kinds of current collectors. This makes it possible to prevent the occurrence of shear force originated from the difference in elongation percentage of the two different current collectors. As such, by having the above configuration, it is possible to inhibit the occurrence of cracks. Therefore, it is possible to easily manufacture a high-performance all-solid-state battery in which the performance degradation due to cracking is inhibited.

In the present disclosure, the roll press may be a hot roll press. Here, “hot roll press” in the present disclosure means that the roll press is carried out on a heated stack. It specifically means that the roll press is carried out on a stack heated to a temperature of no less than 100° C. and less than the temperature at which the solid electrolyte produces heat due to an oxidation reaction (if the solid electrolyte is a sulfide solid electrolyte for example, approximately 200° C.), more specifically, for example no less than 100° C. and no more than 200° C., and no less than 150° C. and no more than 200° C.

By having such a configuration, it is possible to easily increase the density of the first and second active material layers, whereby it gets easy to manufacture a high-performance all-solid-state battery.

In the present disclosure wherein the roll press is a hot roll press, the second current collector may include a conductive layer containing a conductive material and a resin. Here, the second current collector is not limited as long as it is formed to function as a current collector of an all-solid-state battery. The second current collector may be formed only from the above-described resin layer, may include the conductive material and the resin layer, and may include a nonconductive material and the resin layer. The resin layer includes a conductive material and a resin that expands at a predetermined temperature, and functions as a so-called PTC (Positive Temperature Coefficient) element. This resin layer may be formed in a film, may have a configuration in which a porous body is immersed in the conductive material and the resin, so that the resin layer is kept by the porous body. Even if an all-solid-state battery including a PTC element is manufactured via a hot roll press, the situation in which the resin of the PTC element expands at the hot roll press can be prevented in the present disclosure, because the second current collector including the PTC element is arranged after the hot roll press. This makes it possible to manufacture an all-solid-state battery in which the function of PTC element, which increases the resistance at a predetermined temperature by the expansion of the resin, is not developed.

In the present disclosure, a stacking face of the first current collector and a stacking face of the second current collector, whose normal directions are in a stacking direction of each layer of the stack, may have the same shape; in arranging the second current collector, the second current collector may be arranged in a manner that the second active material layer is arranged at a central portion of the second current collector, the second current collector including an insulation material at an outer edge portion of the stacking face, the central portion being surrounded by the insulation material; and the first current collector may be an anode current collector and the second current collector may be a cathode current collector.

By having such a configuration, it is possible to arrange the insulation material around the second active material layer. Whereby, it is possible to inhibit the performance degradation originated from the arrangement of the insulation material on the second active material layer. Further, by making the shapes of the stacking faces of the first and second current collectors the same, it is possible to easily arrange the second current collector on the second active material layer in arranging the second current collector.

In the present disclosure wherein the staking face of the first current collector and the stacking face of the second current collector have the same shape, the insulation material may be further arranged on a part of a tab extended outside from the outer edge portion of the second current collector, continuously from the outer edge portion. By having such a configuration, it is possible to easily arrange the insulation material to the tab, therefore it gets easy to increase the productivity of the all-solid-state battery. In addition, by arranging the insulation material to the tab, it gets easy to prevent electric conduction between the first current collector and the second current collector, therefore it gets easy to manufacture a high-performance all-solid-state battery.

According to the present disclosure, it is possible to provide a method for manufacturing an all-solid-state battery, with which a high performance all-solid-state battery can easily be manufactured.

### BRIEF DESCRIPTION OF DRAWINGS

FIG. 1 is a view to explain a method for manufacturing an all-solid-state battery of the present disclosure according to a first embodiment;

FIG. 2 is a view to explain the method for manufacturing an all-solid-state battery of the present disclosure according to the first embodiment;

FIG. 3 is a view to explain a method for manufacturing an all-solid-state battery of the present disclosure according to a second embodiment;

FIG. 4 is a view to explain the method for manufacturing an all-solid-state battery of the present disclosure according to the second embodiment;

FIG. 5 is a view to explain a method for manufacturing an all-solid-state battery of the present disclosure according to a third embodiment;

FIG. 6 is a view to explain the method for manufacturing an all-solid-state battery of the present disclosure according to the third embodiment;

FIG. 7 is a top view to explain a stack 4y;

FIG. 8 is a top view to explain a cathode current collector 3ai;

FIG. 9 is a cross-sectional view to explain the cathode current collector 3ai;

FIG. 10 is a cross-sectional view to explain a battery element 8;

FIG. 11 is a view to explain a method for manufacturing an all-solid-state battery of the present disclosure according to a fourth embodiment; and

FIG. 12 is a view to explain the method for manufacturing an all-solid-state battery of the present disclosure according to the fourth embodiment.

### DESCRIPTION OF EMBODIMENTS

Hereinafter the present disclosure will be explained with reference to the drawings. In the explanation bellow, the first current collector is an anode current collector, the second current collector is a cathode current collector, the first active material layer is an anode active material layer, and the second active material layer is a cathode active material layer. This embodiment is one example of the present disclosure, and the present disclosure is not limited to the embodiments shown below.

### 1. First Embodiment

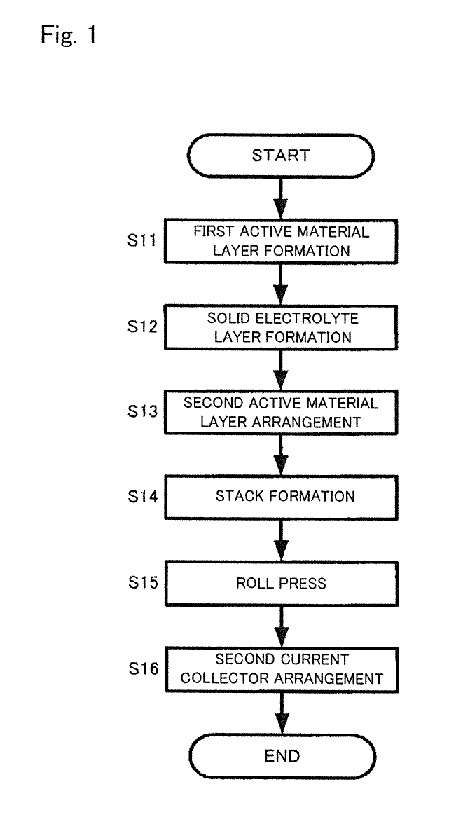

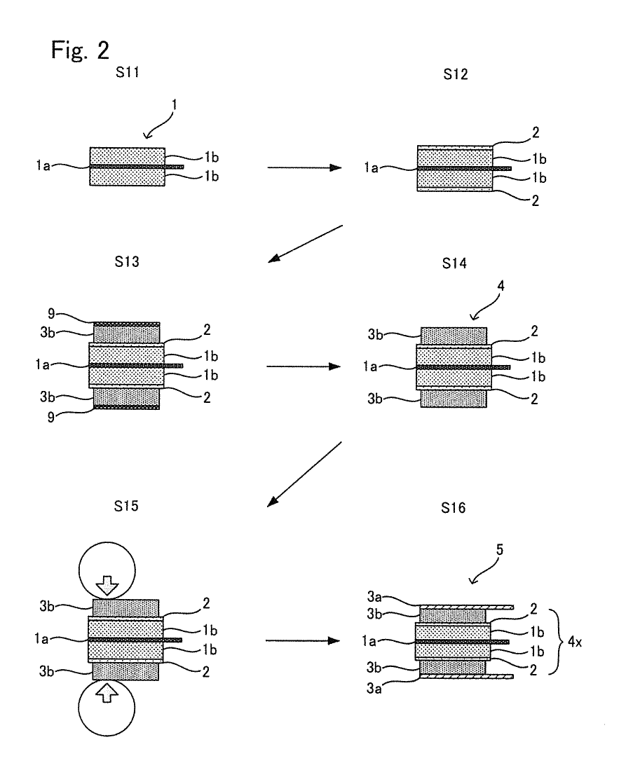

FIGS. 1 and 2 are views to explain a method for manufacturing an all-solid-state battery of the present disclosure according to a first embodiment. The manufacturing method of the present disclosure shown in FIGS. 1 and 2 includes a first active material layer formation step (S11), a solid electrolyte layer formation step (S12), a second active material layer arrangement step (S13), a stack formation step (S14), a roll press step (S15), and a second current collector arrangement step (S16).

### 1.1. First Active Material Layer Formation Step (S11)

The first active material layer formation step (hereinafter may be simply referred to as “S11”) is a step of forming an anode active material layer 1b to each of a right face and a reverse face of an anode current collector 1a. S11 is not particularly limited as long as the anode active material 1b is formed to both faces (right and reverse) of the anode current collector 1a. In S11, for example, the anode active material layer 1b is formed on the right face of the anode current collector 1a, via a process of applying an anode composition in a slurry form manufactured by dispersion of at least an anode active material in a solvent, to the right face of the anode current collector 1a, and drying it. Next, the anode active material layer 1b is formed on the reverse face of the anode current collector 1a, via a process of applying the above-described anode composition in a slurry form to the reverse face of the anode current collector 1a and drying it. S11 may be a step of manufacturing the anode 1 including the anode current collector 1a and the anode active material layer 1b formed on both faces of the anode current collector 1a, by formation of the anode active material layer 1b on each of the right and reverse faces of the anode current collector 1a, as described for example.

The anode 1 manufactured in S11 is thereafter cut out in a product shape.

### 1.2. Solid Electrolyte Layer Formation Step (S12)

The solid electrolyte layer formation step (hereinafter may be simply referred to as “S12”) is a step of forming the solid electrolyte layer 2 on each anode active material layer 1b formed in S11. S12 is not particularly limited as long as the solid electrolyte layer 2 is formed on each anode active material layer 1b formed in S11. In S12, for example, the solid electrolyte layer 2 is formed on one anode active material layer 1b included in the pair of anode active material layers 1b, 1b formed in S11, via a process of applying an electrolyte composition in a slurry form manufactured by dispersion of at least a solid electrolyte in a solvent, on the anode active material layer 1b formed on the right face of the anode current collector 1a and drying it. Next, the solid electrolyte layer 2 is formed on the other anode active material layer 1b included in the pair of anode active material layers 1b, 1b formed in S11, via a process of applying the above-described electrolyte composition in a slurry form on the anode active material layer 1b formed on the reverse face of the anode current collector 1a and drying it. S12 may be a step of forming the solid electrolyte layer 2 on each anode active material layer 1b formed in S11 as described for example.

### 1.3. Second Active Material Arrangement Step (S13)

The second active material layer arrangement step (hereinafter may be simply referred to as “S13”) is a step of arranging a cathode active material layer 3b arranged on a base material 9, in such a manner that the solid electrolyte layer 2 and the cathode active material layer 3b have contact with each other. Here, the manufacturing method of the cathode active material layer 3b arranged on the base material 9 is not particularly limited. The cathode active material layer 3b arranged on the base material 9 may be formed for example via a process of applying a cathode composition in a slurry form manufactured by dispersion of at least a cathode active material in a solvent on the surface of the base material 9 and drying it, thereafter cutting out the cathode active material layer into a product size.

The size of the stacking face of the cathode active material layer 3b, whose normal direction is in the stacking direction of each layer of the stack 4 described later, is not particularly limited, and in view of easy securement of the insulation property between the cathode active material layer 3 and the anode 1, the stacking face of the cathode active material layer 3b may be smaller than the stacking face of the anode active material layer 1b.

### 1.4. Stack Formation Step (S14)

The stack formation step (hereinafter may be simply referred to as “S14”) is a step of forming the stack 4 including the cathode active material layer 3b, the solid electrolyte layer 2, the anode active material layer 1b, the anode current collector 1a, the anode active material layer 1b, the solid electrolyte layer 2 and the cathode active material layer 3b, stacked from one side to the other side in the order mentioned, by removing each base material 9 having contact with each cathode active material layer 3b arranged on the solid electrolyte layer 2 in S13. S14 is not particularly limited as long as the base material 9 is removed. For example, S14 may be a step of stacking the cathode active material layer 3b on each solid electrolyte layer 2 in S13, thereafter pressing the cathode active material layer 3b and the solid electrolyte layer 2 in a direction to make them tightly have contact with each other, to transfer the cathode active material layer 3b from the base material 9 to the solid electrolyte layer 2, thereafter removing the base material 9 to which the cathode active material layer 3b is not attached. S14 may be a step of manufacturing the stack 4 by removal of the base material 9 as described above for example.

For example, when the base material 9 is an Al foil, the cathode active material layer 3b can be easily transferred on the solid electrolyte layer 2 by no less than 200 MPa of press pressure.

### 1.5. Roll Press Step (S15)

The roll press step (hereinafter may be simply referred to as “S15”) is a step of carrying out a roll press on the stack 4 formed in S14. By carrying out a roll press, the densities of the anode active material layer 1b, the solid electrolyte layer 2, and the cathode active material layer 3b can increase. Thus it gets easier to improve the performance of the all-solid-state battery.

In S15, the pressure and temperature at the roll press may be properly determined corresponding to the target value of the density of each layer described above after the roll press. In view of easy increase of the density of each layer described above, the linear pressure of the roll press may be no less than 19.6 kN/cm. The temperature at the roll press may be at a room temperature for example.

### 1.6. Second Current Collector Arrangement Step (S16)

The second current collector arrangement step (hereinafter may be simply referred to as “S16”) is a step of forming a battery element 5 including: the stack 4 on which a roll press is carried out in S15 (hereinafter may be referred to as “stack 4x”); and a cathode current collector 3a arranged on each of the upper side and the lower side of the stack 4x, by arranging the cathode current collector 3a on each cathode active material 3b provided to the stack 4x. The S16 is not particularly limited as long as the cathode current collector 3a can be arranged on each cathode active material layer 3b provided to the stack 4x. In view of easy formation of the battery element 5 that can easily be treated when transported and the like, S16 may be a step of arranging the cathode current collector 3a, cut out into a product size, on the cathode active material layer 3b via an adhesive. In this case, the adhesive may be a conductive adhesive, may be a non-conductive adhesive, may be a thermosetting adhesive, and may be a thermoplastic adhesive. When the cathode current collector 3a is arranged on the cathode active material layer 3b via a non-conductive adhesive, the area of the adhesive having contact with the stacking face of the cathode active material layer 3b may be no more than 10% of the effective area for charge/discharge of the stacking face of the cathode active material layer 3b, in view of easy manufacture of a high performance all-solid-state battery. For the cathode current collector 3a to be arranged in S16, an Al foil may be used for example.

In the first embodiment of the present disclosure in which the battery element 5 (all-solid-state battery) is manufactured via S11 to S16, the second current collector arrangement step (S16) in which the cathode current collector 3a is arranged is carried out after the roll press step (S16). By having such a configuration, the number of the current collectors provided to the stack to be roll pressed may be determined to one kind, therefore it is possible to make a configuration in which a share force in the roll press is difficult to occur. By inhibiting the share force in the roll press, cracks in each layer of the stack may be inhibited. By preventing each layer from cracking, an all-solid-state battery whose performance is easily improved may be manufactured. Thus, according to the first embodiment of the present disclosure, it is possible to easily manufacture a high performance all-solid-state battery.

In the above explanation related to the present disclosure, a configuration having a roll press step in which a roll press is carried out at a room temperature is shown as an example. However, the present disclosure is not limited to this configuration. In view of manufacturing an all-solid-state battery whose performance can be easily improved by further increasing the density of each layer (anode active material layer, solid electrolyte layer and cathode active material layer) of the battery element, a configuration having a hot roll press step in which a roll press is carried out on the stack that is heated may be taken. The present disclosure having such a configuration will be described below.

### 2. Second Embodiment

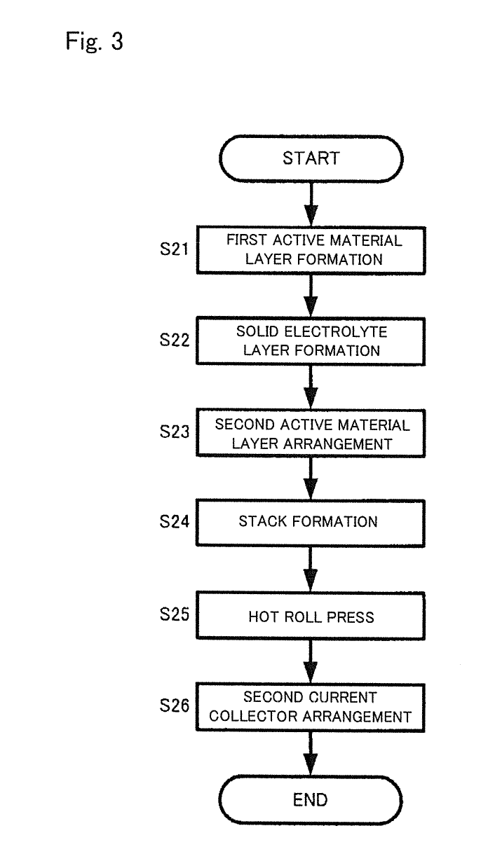

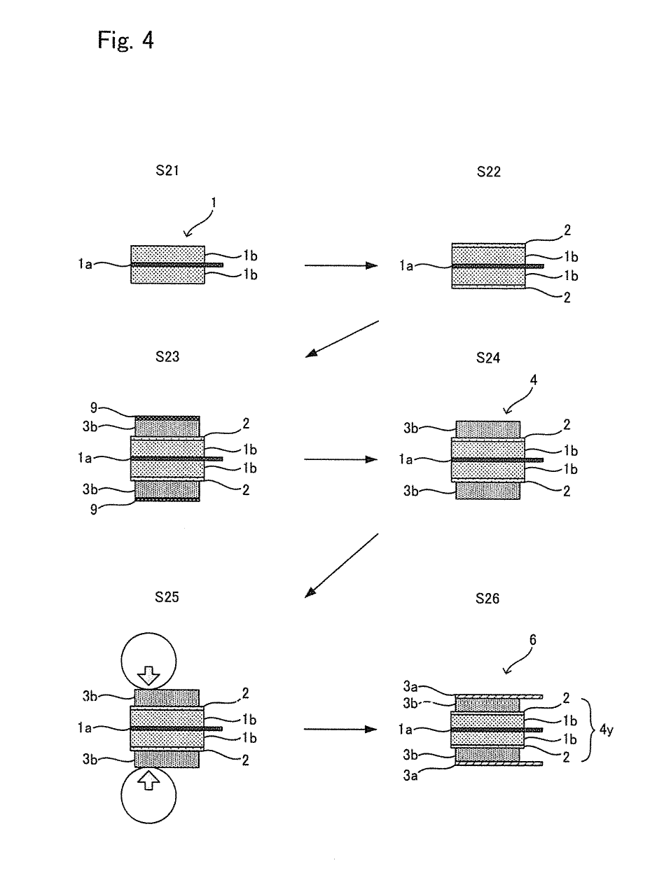

FIGS. 3 and 4 are views to explain a method for manufacturing an all-solid-state battery of the present disclosure according to a second embodiment. The manufacturing method of the present disclosure shown in FIGS. 3 and 4 includes a first active material layer formation step (S21), a solid electrolyte layer formation step (S22), a second active material layer arrangement step (S23), a stack formation step (S24), a hot roll press step (S25), and a second current collector arrangement step (S26).

Steps from the first active material layer formation step (S21) to the stack formation step (S24) are the same as the above first active material formation step (S11) to the stack formation step (S14). Thus the explanations thereof are omitted here.

### 2.1. Hot Roll Press Step (S25)

The hot roll press step (hereinafter may be simply referred to as “S25”) is a step of carrying out a hot roll press on the stack 4 formed in the stack formation step (S24). More specifically, it is a step of carrying out a roll press on the stack 4, while heating the stack 4 at a temperature of no less than 100° C. and less than a temperature at which the solid electrolyte produces heat due to oxidation reaction (e.g. 170° C.). When a hot roll press is carried out, the linear pressure may be the same as or lower than that in a roll press. By carrying out a hot roll press, the densities of the anode active material layer 1b, the solid electrolyte layer 2, and the cathode active material layer 3b are easily increased, and as a result, the ion conductive resistance and the electron conductive resistance are easily reduced. Thus, the performance of the all-solid-state battery may be easily increased. In the following explanation, the stack 4 after a hot roll press is carried out is referred to as stack 4y.

### 2.2. Second Current Collector Arrangement Step (S26)

The second current collector arrangement step (in the following explanation regarding the second embodiment, it may be simply referred to as “S26”) is a step of forming a battery element 6 including the stack 4y and the cathode current collector 3a arranged on each of the upper side and lower side of the stack 4y, by arranging the cathode current collector 3a on each cathode active material layer 3b included in the stack 4y on which a hot roll press is carried out in S25. S26 is the same step as S16 except that the stack on which the cathode current collector 3a is to be arranged is the stack 4y that went through the hot roll press, and the battery element to be formed is the battery element 6.

In the second embodiment of the present disclosure in which the battery element 6 (all-solid-state battery) is manufactured via S21 to S26 as well, the second current collector arrangement step (S26) in which the cathode current collector 3a is arranged is carried out after the hot roll press step (S25). With this configuration, it is possible to determine to be one kind the number of the current collectors to be arranged in the stack on which the hot roll press is to be carried out. Thus, it is possible to have a configuration that a shear force is difficult to occur in the hot roll press. By inhibiting the shear force in the hot roll press, it is possible to inhibit cracks in each layer of the stack. Therefore it is possible to manufacture an all-solid-state battery (battery element 6) that can easily improve its performance because each layer has no cracks. Thus, according to the above-described second embodiment of the present disclosure, it is possible to easily manufacture an all-solid-state battery of high performance.

In addition, the second embodiment of the present disclosure has the hot roll press step, therefore the battery element 6 includes high density anode active material layer 1b, solid electrolyte layer 2 and cathode active material layer 3b. By having such a configuration, the ion conductive resistance and the electron conductive resistance are easily reduced, and therefore an all-solid-state battery (battery element 6) that can further easily improve its performance may be manufactured.

In the above explanation regarding the present disclosure, a configuration in which the cathode current collector is an Al foil is shown as an example. However, the present disclosure is not limited to this configuration. The cathode current collector in the present disclosure is not limited as long as formed of an electroconductive material that can endure the use environment of the all-solid-state battery, and may be a conductive layer (PTC film) including a conductive material and a resin that expands at a predetermined temperature (e.g. no less than 150° C.), or may by a metal foil whose surface is coated with the conductive layer (PTC film). The present disclosure having a configuration in which the cathode current collector is a PCT film will be explained hereinafter.

### 3. Third Embodiment

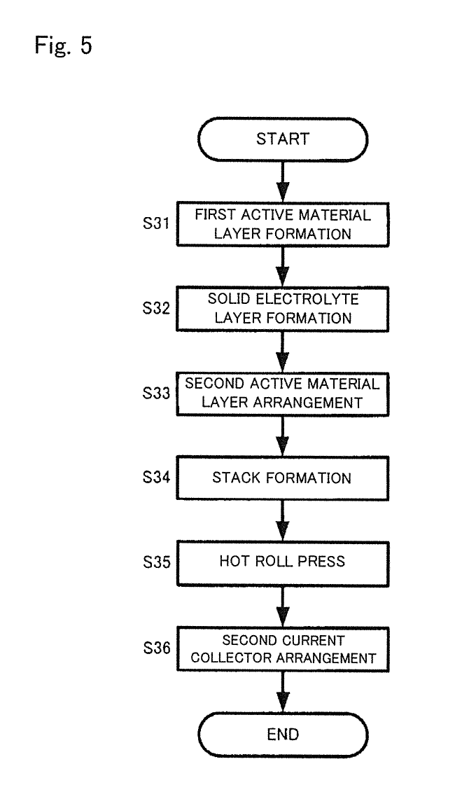

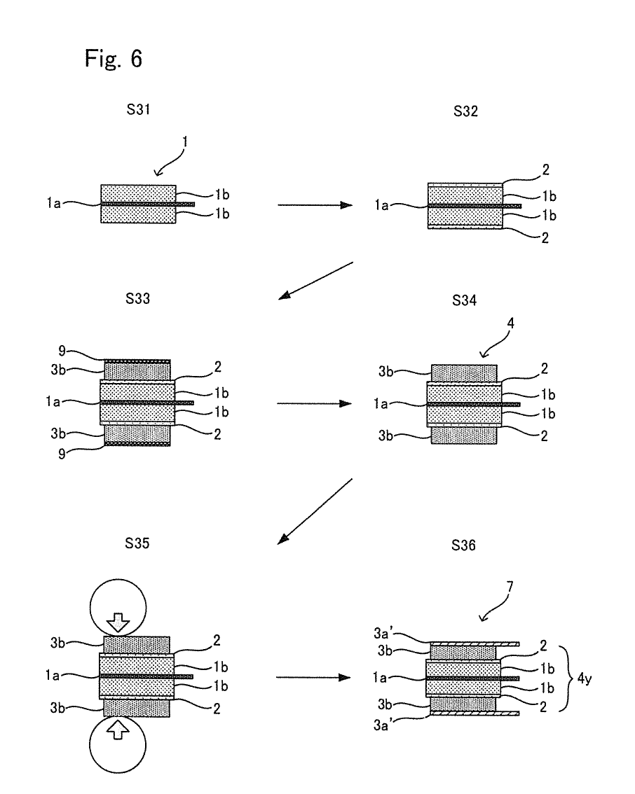

FIGS. 5 and 6 are views to explain a method for manufacturing an all-solid-state battery of the present disclosure according to a third embodiment. The manufacturing method of the present disclosure shown in FIGS. 5 and 6 includes a first active material layer formation step (S31), a solid electrolyte layer formation step (S32), a second active material layer arrangement step (S33), a stack formation step (S34), a hot roll press step (S35), and a second current collector arrangement step (S36).

The steps from the first active material layer formation step (S31) to the stack formation step (S34) are the same as the above-described first active material layer formation step (S11) to the stack formation step (S14). Thus the explanations thereof are omitted here.

### 3.1. Hot Roll Press Step (S35)

The hot roll press step (in the following explanation regarding the third embodiment, it may be simply referred to as “S35”) is a step of carrying out a hot roll press on the stack 4 formed in the stack formation step (S34). S35 is the same step as S25.

### 3.2. Second Current Collector Arrangement Step (S36)

The second current collector arrangement step (in the following explanation regarding the third embodiment, it may be simply referred to as “S36”) is a step of forming a battery element 7 including the stack 4y and the cathode current collector 3a′ arranged on each of the upper side and the lower side of the stack 4y, by arranging the cathode current collector 3a′ which is a PTC film on each cathode active material layer 3b included in the stack 4y on which a hot roll press is carried out in S35. In S36, the cathode current collector 3a′ to be arranged on the cathode active material layer 3b may be cut into a product size. S36 is the same step as the above-described S16 except that the cathode current collector 3a′ is used instead of the cathode current collector 3a and the battery element formed is the battery element 7.

In the third embodiment of the present disclosure in which the battery element 7 (all-solid-state battery) is manufactured via S31 to S36 as well, the second current collector arrangement step (S36) in which the cathode current collector 3a′ is arranged is carried out after the hot roll press step (S35). With this configuration, it is possible to determine to be one kind the number of the current collector to be provided to the stack, therefore it is possible to make a configuration in which a shear force is difficult to occur in the hot roll press. By inhibiting the shear force in the hot roll press, it is possible to reduce cracks in each layer of the stack, therefore it is possible to manufacture an all-solid-state battery (battery element 7) whose performance is easily improved because each layer does not have cracks. Therefore, according to the third embodiment, it is possible to easily manufacture an all-solid-state battery of high performance.

Because the third embodiment of the present disclosure includes the hot roll press step, the battery element 7 includes the high-density anode active material layer 1b, solid electrolyte layer 2, and cathode active material layer 3b. By having such a configuration, the ion conductive resistance and the electron conductive resistance are easily reduced, therefore it is possible to manufacture an all-solid-state battery (battery element 7) that can further easily improve its performance.

Further, the cathode current collector 3a′ used in the third embodiment of the present disclosure is a PTC film. If the melting point of the resin used for the PTC film is the same as or lower than the temperature in the hot roll press, the PTC film expands in the hot roll press and the electron conductive resistance of the PTC film increases when the hot roll press is carried out after the cathode current collector (PTC film) is arranged as before. The all-solid-state battery including the PTC film of such a configuration is low in performance. Therefore, all-solid-state batteries including PTC films manufactured by the conventional method are low in performance.

In contrast, in the present disclosure, the cathode current collector (PTC film) is arranged after the hot roll press is carried out. Therefore it is possible to manufacture an all-solid-state battery including a PTC film which is not expanded (PTC film whose electron conductive resistance is not increased). Such an all-solid-state battery has a higher performance than that of an all-solid-state battery including a PTC film whose electron conductive resistance is increased. Therefore, according to the present disclosure, it is possible to easily manufacture a high-performance all-solid-state battery. It is noted that in an all-solid-state battery including a PTC film, the PTC film expands when the temperature of the all-solid-state battery is excessively increased for some reason. Because of this, the electron conductive path between the adjacent conductive materials provided in the PTC film is cut off, and the transfer of electrons is inhibited. As a result, it gets easy to sustain the safety of the all-solid-state battery.

In the present disclosure, the size of the stacking face of the cathode active material layer and the size of the stacking face of the anode active material layer are not particularly limited. However, in view of easy inhibition metal precipitation (dendrite growth), the size of the stacking face of the cathode active material layer may be smaller than the size of the stacking face of the anode active material layer. For example, the insulation property between the cathode and anode may be easily secured by forming a solid electrolyte layer having a stacking face same in size as that of the anode active material layer, and on the solid electrolyte layer, forming a cathode active material having a stacking face smaller than that of the anode active material layer.

In the present disclosure, the size of the stacking face of the cathode current collector and the size of the stacking face of the anode current collector are not particularly limited. For example, when making the stacking face of the cathode active material layer smaller than the stacking face of the anode active material layer, it is also possible to make the stacking face of the cathode current collector smaller than the stacking face of the anode current collector. Meanwhile, in view of easy manufacture of an all-solid-state battery by making it easy to arrange the cathode current collector on the cathode active material layer, the stacking face of the cathode current collector and the stacking face of the anode current collector may have the same shape. Hereinafter the present disclosure including the cathode current collector and the anode current collector whose stacking faces have the same shape will be explained.

### 4. Fourth Embodiment

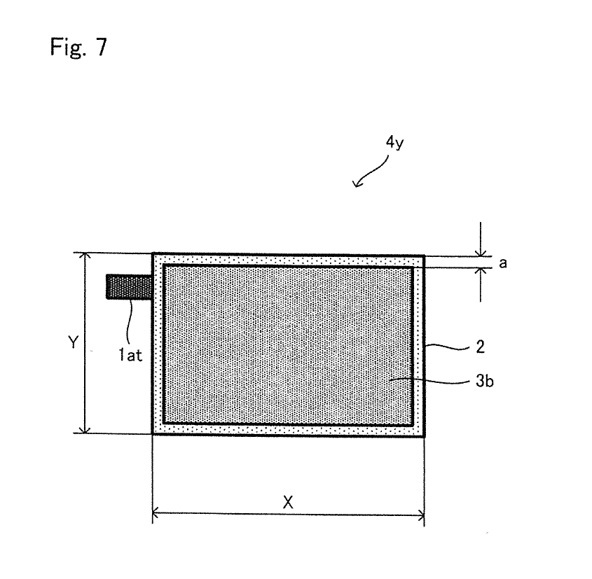

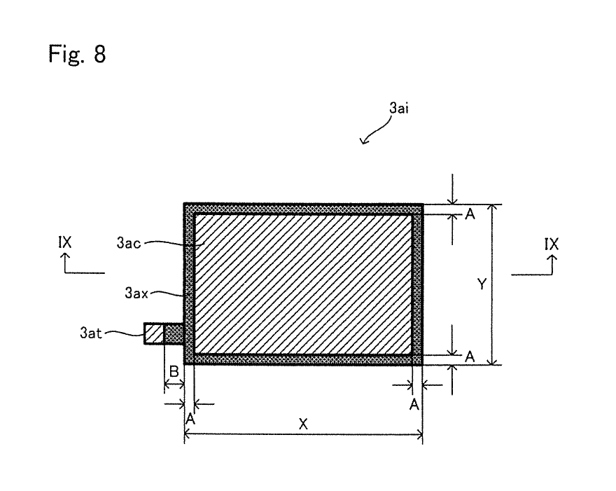

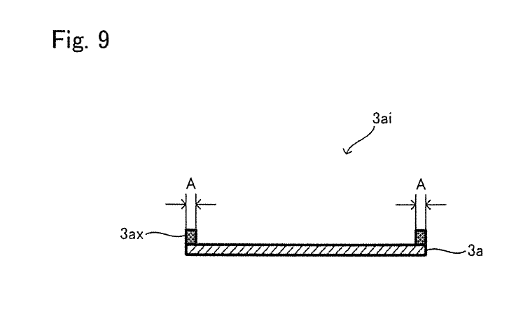

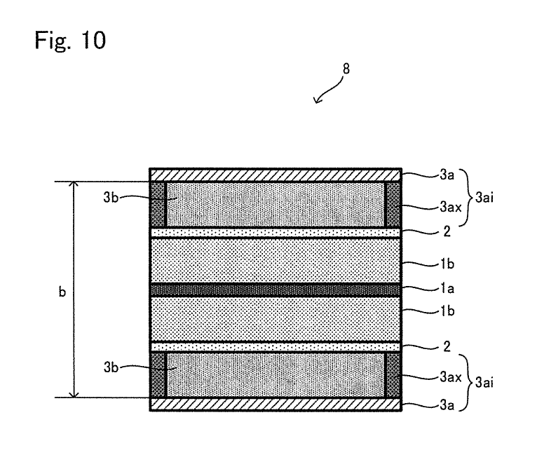

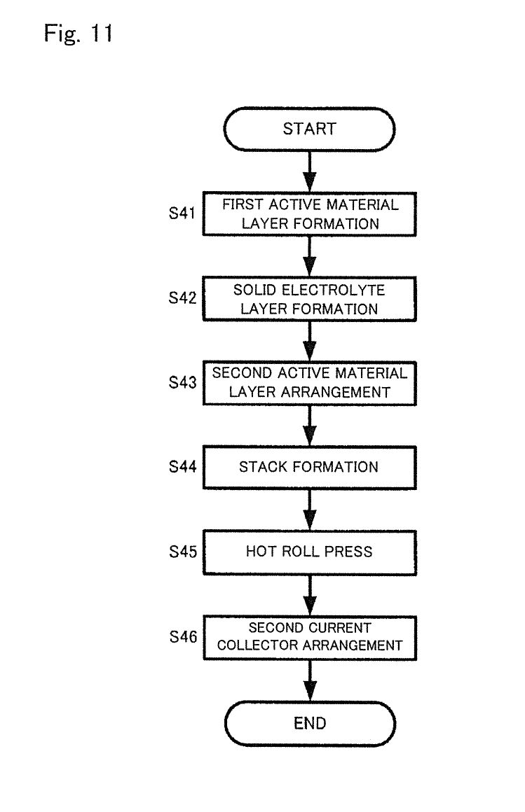

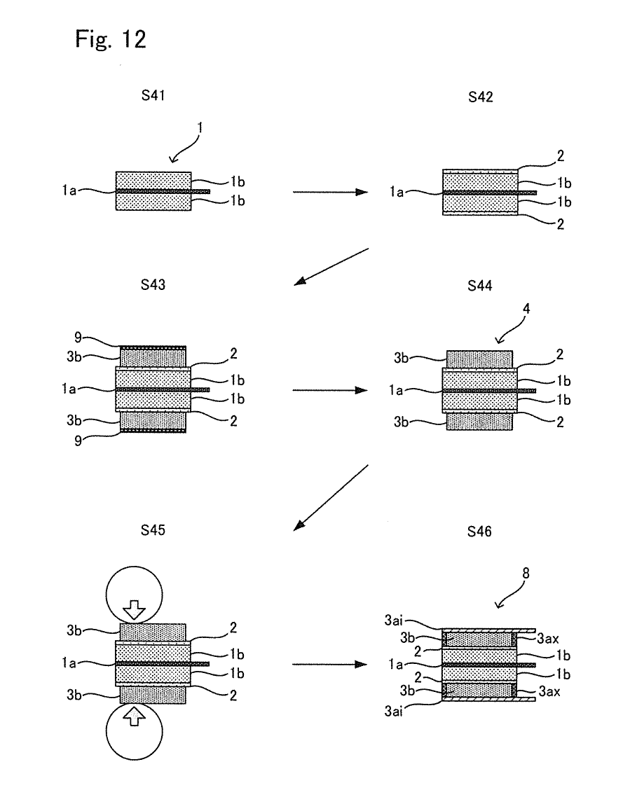

A fourth embodiment of the present disclosure is a configuration in which the size of the stacking face of the cathode active material layer is smaller than the size of the stacking face of the anode active material layer, and the cathode current collector 3a′ and the anode current collector 1a whose stacking faces have the same shape are used. FIG. 7 is a top view to explain the stack 4y used in the method for manufacturing an all-solid-state battery of the present disclosure according to a fourth embodiment. The backward to forward direction in FIG. 7 is the stacking direction. FIG. 8 is a top view to explain a cathode current collector 3ai. The backward to forward direction in FIG. 8 is the stacking direction. FIG. 9 is an IX-IX cross section of FIG. 8. FIG. 10 shows a cross section of a battery element 8 cut along a surface in which a tab 1at of the anode current collector and a tab 3at of the cathode current collector do not exist. FIGS. 11 and 12 are views to explain the method for manufacturing an all-solid-state battery of the present disclosure according to the fourth embodiment. Hereinafter, the fourth embodiment of the present disclosure will be explained with reference to FIGS. 7 to 12.

As shown in FIG. 7, the size of the stacking face of the cathode active material layer 3b is smaller than the size of the stacking face of the solid electrolyte layer 2. Viewing the stack 4y from the above, it is possible to confirm that an outer edge portion of the solid electrolyte layer 2 exists around the cathode active material layer 3b, and that the tab 1 at of the anode current collector extending outside the solid electrolyte layer 2.

As shown in FIGS. 8 to 10, the cathode current collector 3ai includes the cathode current collector 3a, and an insulation member 3ax arranged on the outer edge portion of the stacking face of the cathode current collector 3a. Further, the insulation material 3ax is also arranged at a part of the tab 3at (portion on the above-described outer edge portion side) formed in a manner to extend from a part of the outer edge portion of the cathode current collector 3ai to the outside. As shown in FIGS. 7 to 9, the longitudinal length of the stacking face of the anode current collector 1a and the longitudinal length of the stacking face of the cathode current collector 3ai are each Y. The traverse length of the stacking face of the anode current collector 1a and the traverse length of the stacking face of the cathode current collector 3ai are each X. The shape of the insulation material 3ax arranged on the outer edge portion of the stacking face of the cathode current collector 3ai, except the portion arranged on the part of the tab 3at, is the same as the shape of the outer edge portion of the solid electrolyte layer 2 existing around the cathode active material layer 3b. In addition, the insulation material 3ax is not arranged at a central portion 3ac of the stacking face of the cathode current collector 3ai surrounded by the insulation material 3ax. The shape of the central portion 3ac is the same as the shape of the stacking face of the cathode active material layer 3b.

The manufacturing method of the present disclosure shown in FIGS. 11 and 12 includes a first active material layer formation step (S41), a solid electrolyte layer formation step (S42), a second active material layer arrangement step (S43), a stack formation step (S44), a hot roll press step (S45), and a second current collector arrangement step (S46).

The first active material layer formation step (S41) and the solid electrolyte layer formation step (S42) are the same as the above-described first active material layer formation step (S11) and the solid electrolyte layer formation step (S12), therefore the explanations thereof are omitted here.

### 4.1. Second Active Material Layer Arrangement Step (S43)

The second active material layer arrangement step (in the following explanation regarding the fourth embodiment, it may be simply referred to as “S43”) is a step of arranging the cathode active material layer 3b arranged on the base material 9, on each solid electrolyte layer 2 formed in the solid electrolyte layer formation step (S42), in a manner to make the solid electrolyte layer 2 and the cathode active material layer 3b have contact with each other. The size of the stacking face of the cathode active material layer 3b to be arranged on the solid electrolyte layer 2 in S43 is smaller than the size of each stacking face of the solid electrolyte layer 2 and the anode active material layer 1b. S43 is a step of arranging the cathode active material layer 3b in a manner to make the central portion surrounded by the outer edge portion of the stacking face of the solid electrolyte layer 2 and the cathode active material layer 3b have contact with each other, without arranging the cathode active material layer 3b on the outer edge portion of the stacking face of the solid electrolyte layer 2.

### 4.2. Stack Formation Step (S44)

The stack formation step (in the following explanation regarding the fourth embodiment, it may be simply referred to as “S44”) is a step of forming the stack 4, by removing each base material 9 having contact with the cathode active material layer 3b arranged on the solid electrolyte layer 2 in S43. S44 is the same step as the above-described S14.

### 4.5. Hot Roll Press Step (S45)

The hot roll press step (in the following explanation regarding the fourth embodiment, it may be simply referred to as “S45”) is a step of carrying out a hot roll press on the stack 4 formed in S44. S45 is the same step as S25.

### 4.6. Second Current Collector Arrangement Step (S46)

The second current collector arrangement step (in the following explanation regarding the fourth embodiment, it may be simply referred to as “S46”) is a step of arranging the cathode current collector 3ai on each cathode active material layer 3b provided to the stack 4y on which a hot roll press is carried out in S45. More specifically, S46 is a step of forming a battery element 8 including the stack 4y and the cathode current collector 3ai arranged on the upper side and the lower side of the stack 4y, by arranging the cathode current collector 3ai on each cathode active material layer 3b provided to the stack 4y, in a manner to make the central portion 3ac of the stacking face of the cathode current collector 3ai and the cathode active material layer 3b have contact with each other and to make the insulation material 3ax arranged on the outer edge portion of the stacking face of the cathode current collector 3ai and the outer edge portion of the stacking face of the solid electrolyte layer 2 have contact with each other. S46 is the same step as the above-described S16 except that the cathode current collector 3ai is used instead of the cathode current collector 3a, and the battery element formed is the battery element 8.

The cathode current collector 3ai arranged on the cathode active material layer 3b in S46 may be produced by arranging the insulation material 3ax on the outer edge portion of the stacking face of the cathode current collector 3a and at a part of the tab 3at extending outside from a part of the outer edge portion. The method for arranging the insulation material 3ax is not particularly limited, and for example it may be produced by coating an insulation composition in a slurry form that functions as an adhesive as well, produced by dispersing a non-conductive resin, a solid electrolyte and the like in a solvent, onto the above-described portion by patterning and the like.

In S46, the insulation material 3ax that functions as an adhesive as well is arranged on the outer edge portion of the stacking face of the cathode current collector 3a and at a part of the tab 3at extending outside from a part of the outer edge portion. This is for making it possible to form the battery element 8 that is easily handled when transported after S46 and the like. The cathode current collector 3ai on which the insulation material 3ax that functions as an adhesive as well is arranged may be produced for example by applying an insulation composition heated to the temperature same as or higher than the temperature at which a thermoplastic resin which is a non-conductive resin starts to soften, onto the above-described portion of the cathode current collector 3a. Then, while the thermoplastic resin is soft, the cathode current collector 3ai may be arranged onto the cathode active material layer 3b. In addition, a configuration of applying an insulation composition including a binder as a non-conductive resin onto the above-described portion of the cathode current collector 3a, and before the composition gets dry, arranging the cathode current collector 3ai onto the cathode active material layer 3b, or a configuration of putting a non-conductive adhesion tape on the above-described portion of the cathode current collector 3a, thereafter arranging the cathode current collector 3ai onto the cathode active material layer 3b may be taken.

In the fourth embodiment of the present disclosure in which the battery element 8 (all-solid-state battery) is manufactured via S41 to S46 as well, the second current collector arrangement step (S46) in which the cathode current collector 3ai is arranged is carried out after the hot roll press step (S45). By having such a configuration, it is possible to determine the number of the current collectors provided to the stack on which the hot roll press is to be carried out to be one kind, therefore it is possible to have a configuration in which a shear force is difficult to occur in the hot roll press. By inhibiting the shear force in the hot roll press, cracks in each layer of the stack can be inhibited, therefore it is possible to manufacture an all-solid-state battery (battery element 8) whose performance can be easily improved because each layer does not have cracks. Therefore, according to the fourth embodiment, it is possible to easily manufacture an all-solid-state battery of high performance.

In addition, because the fourth embodiment includes the hot roll press step, the battery element 8 includes a high-density anode active material layer 1b, solid electrolyte layer 2, and cathode active material layer 3b. By having such a configuration, the ion conductive resistance and the electron conductive resistance can be easily reduced, therefore it is possible to manufacture an all-solid-state battery (battery element 8) whose performance can be further improved.

Further, because the insulation material 3ax is arranged around the cathode active material layer 3b in the fourth embodiment, it is easy to prevent the short circuit between the cathode and anode. This makes it possible to easily improve the performance of the all-solid-state battery.

Further, because the insulation material 3ax is arranged around the cathode active material layer 3b in the fourth embodiment, it is possible to optimize the effective area for charge/discharge in the stacking face of the cathode active material layer 3b. This makes it possible to easily improve the performance of the all-solid-state battery.

In addition, in the fourth embodiment, the cathode current collector 3ai and the anode current collector 1a whose stacking faces are in the same shape are used. This makes it possible to easily determine the position of the cathode current collector 3ai, therefore it gets easy to increase the manufacturing efficiency of the all-solid-state battery.

In the fourth embodiment, the width of the outer edge portion of the stacking face of the cathode current collector 3a shown in FIG. 8 (width of the portion where the insulation material is to be arranged excepting the tab) is determined as A, and the width of the portion of the tab where the insulation material is to be arranged is determined as B. Also, the width of the outer edge portion of the stacking face of the solid electrolyte layer 2 existing around the cathode active material layer 3b shown in FIG. 7 is determined as a, and the thickness of the portion of the battery element 8 shown in FIG. 10, excepting the cathode current collector 3a, is determined as b. At this time, a≦A may be taken, in view of making it possible to manufacture an all-solid-state battery in which a short circuit is easily prevented by making the insulation material Sax have contact with whole outer edge portion of the stacking face of the solid electrolyte layer 2. Meanwhile, A<2a may be taken, in view of making it possible to manufacture an all-solid-state battery whose performance is easily improved by making the effective area for charge/discharge of the cathode active material layer 3b large. That is, in the present disclosure, a≦A<2a may be taken. Meanwhile, 0.5b<B may be taken in view of making it possible to manufacture an all-solid-state battery in which a short circuit between the cathode and anode is easily prevented. Meanwhile, B<1.3b may be taken in view of making it possible to manufacture an all-solid-state battery in which the short circuit between the cathode and anode is easily prevented even when the curved tab of the cathode current collector and the anode current collector have contact with each other. That is, in the present disclosure, 0.5b<B<1.3b may be taken.

In the above explanation, a configuration in which the insulation material Sax that is the same as the insulation material Sax to be arranged on the outer edge portion of the stacking face of the cathode current collector 3a having the width A is arranged on the portion of the width B of the tab Sat is described as an example. However, the present disclosure is not limited to this configuration. The insulation material to be arranged on the portion of the width B may be different from the insulation material to be arranged on the portion of the width A. However, in view of easy increase of the productivity of the all-solid-state battery, the insulation material arranged on the portion of the width A and the insulation material arranged on the portion of the width B may be the same.

The thickness of the insulation material Sax arranged on the cathode current collector 3a is not particularly limited. However, in view of easy manufacture of an all-solid-state battery whose performance is easily improved, the thickness of the insulation material Sax may be the same or smaller than the thickness of the cathode active material layer 3b (e.g. no more than 50 μm).

When an insulation material including a thermoplastic resin is used, a resin that starts softening at the temperature of 100° C. or more may be used as the thermoplastic resin, in view of manufacture of an all-solid-state battery whose performance is easily increased by using an insulation material which does not get soft in the temperature range of normal operation of the all-solid-state battery.

In the above explanation, a configuration in which the insulation material 3ax that functions as an adhesive as well is used is shown as an example. However, the present disclosure is not limited to this configuration. If the cathode current collector on which the adhesive is arranged is arranged in the second current collector arrangement step, in view of manufacturing a battery element which is easily handled after the second current collector arrangement step, the adhesive may also be arranged on the insulation material arranged on the portion excepting the tab. When arranging the adhesive on the insulation material, for example a solution in which a binder is dissolved may be applied on the insulation material arranged on the portion excepting the tab, and before the solution gets dry, the cathode current collector on which the adhesive is arranged may be arranged in the second current collector arrangement step.

In the above explanation regarding the fourth embodiment, a configuration having the hot roll press step is shown as an example of the present disclosure using a cathode current collector and an anode current collector whose stacking faces are in the same shape. However, the present disclosure is not limited to this configuration. The cathode current collector and the anode current collector whose stacking faces are in the same shape may also be used for a configuration having a step of roll press on a stack that is not heated.

In the above explanation, a configuration in which one battery element 5, 6, 7 or 8 is manufactured is shown as an example. However, the present disclosure is not limited to this configuration. The present disclosure may have a configuration in which an all-solid-state battery in which a plurality of battery elements are stacked in the stacking direction is manufactured. When an all-solid-state battery in which a plurality of battery elements are stacked is manufactured, the cathode current collector may be arranged on the upper face and the lower face of each battery element to be stacked. In addition, for example, a configuration in which: among the plurality of battery elements to be stacked, only in the battery element arranged on the lower end, the cathode current collector is arranged on both the upper face and the lower face, and other battery elements are provided with the cathode current collector only on the upper face, and these battery elements are stacked, may be taken. In addition, a configuration in which: among the plurality of battery elements to be stacked, only in the battery element on the upper end, the cathode current collector is arranged on both the upper face and the lower face, and other battery elements are provided with the cathode current collector only on the lower face, and these battery elements are stacked, may be taken.

In addition, as described above, the anode 1 produced in the first active material layer formation step is thereafter cut out into the product shape. This cutting is not limited as long as carried out after the first active material formation step, and for example, it may be carried out at a time point selected from the group consisting of: between the first active material layer formation step and the solid electrolyte layer formation step; between the solid electrolyte layer formation step and the second active material layer formation step; between the stack formation step and the roll press or hot roll press step; between the roll press or hot roll press step and the second current collector arrangement step; and after the second current collector arrangement step.

In the above explanation, a configuration in which the cathode active material layer 3b cut into the product size is arranged on the solid electrolyte layer 2 in the second active material layer arrangement step is shown as an example. However, the present disclosure is not limited to this configuration. However, in view of easy manufacture of the all-solid-state battery, the cathode active material layer 3b cut into the product size may be arranged on the solid electrolyte layer 2 in the second active material layer arrangement step.

In addition, in the above explanation, a configuration in which the cathode current collector cut into the product size is arranged on the cathode active material layer 3b in the second current collector arrangement step is explained as an example. However, the present disclosure is not limited to this configuration. However, in view of easy manufacture of the all-solid-state battery, the cathode current collector cut into the product size may be arranged on the cathode active material layer 3b in the second current collector arrangement step.

In addition, in the present disclosure, the cathode active material layer 3b to be arranged on the solid electrolyte layer 2 in the second active material layer arrangement step and the solid electrolyte layer 2 on which the cathode active material layer 3b is to be arranged may be in a condition that their densities are increased by pressing and the like. However, in view of manufacturing an all-solid-state battery having a configuration in which the performance is easily increased by reducing the ion conductive resistance by increasing the adhesion of the solid electrolyte layer 2 and the cathode active material layer 3b, either one or both of the solid electrolyte layer 2 and the cathode active material layer 3b may be in a condition that its density is not increased, for example by not having a pressing.

In addition, in the present disclosure, metal that can be used for current collectors of all-solid-state battery may be adequately used for the anode current collector 1a and the cathode current collector 3a. Examples of such a metal include a metal material including one or two or more element selected from the group consisting of Cu, Ni, Al, V, Au, Pt, Mg, Fe, Ti, Co, Cr, Zn, Ge and In. In view of manufacturing an all-solid-state battery whose performance is easily improved by inhibiting the reaction of the solid electrolyte and the anode current collector 1a and the cathode current collector 3a, the surface of either one or both of the anode current collector 1a and the cathode current collector 3a may be coated with a carbon material.

In addition, for the anode active material to be contained in the anode active material layer 1b, an anode active material that can be used for all-solid-state batteries may be adequately used. Examples of such an anode active material include carbon active materials, oxide active materials and metal active materials. The carbon active materials are not particularly limited, and examples thereof include mesocarbon micro beads (MCMB), high orientation graphite (HOPG), hard carbons and soft carbons. Examples of oxide active materials include Nb₂O₅, Li₄Ti₅O₁₂ and SiO. Examples of metal active materials include In, Al, Si and Sn. Lithium-containing metal active materials may also be used for the anode active material. The lithium-containing metal active materials are not limited as long as the active material includes at least Li, and it may be Li metal, and may be Li alloy. Examples of Li alloy include alloy containing Li and at least one kind from In, Al, Si and Sn. The shape of the anode active material may be in a particle form, a thin film form, and the like for example. The content of the anode active material in the anode active material layer 1b is not particularly limited, and may be in the range of from 40% to 99% by mass for example.

In addition, in the present disclosure, not only the solid electrolyte layer 2 but also the anode active material layer 1b and the cathode active material layer 3b may include a solid electrolyte that can be used for all-solid-state battery, as necessary. Examples of such a solid electrolyte include oxide-based amorphous solid electrolytes such as Li₂O—B₂O₃—P₂O₅, Li₂O—SiO₂, sulfide-based amorphous solid electrolytes such as Li₂S—SiS₂, LiI—Li₂S—SiS₂, LiI—Li₃PO₄—P₂S₅, Li₂S—P₂S₅ and Li₃PS₄, oxide crystalline and oxynitride crystalline such as LiI, Li₃N, Li₅La₃Ta₂O₁₂, Li₇La₃Zr₂O₂, Li₆BaLa₂Ta₂O₁₂, Li₃PO_{(4-3/2w)}Nw (w<1), and Li_{3.6}Si_{0.6}P_{0.4}O₄. However, in view of easy increase of the performance of the all-solid-state battery, a sulfide solid electrolyte may be used for the solid electrolyte.

Further, the anode active material layer 1b may include a binder to bond the anode active material and the solid electrolyte, and a conductive material to improve the conductivity. Examples of the binder that can be contained in the anode active material layer 1b include acrylonitrile butadiene rubber (ABR), butadiene rubber (BR), polyvinylidene fluoride (PVDF), and styrene-butadiene rubber (SBR). Examples of the conductive material that can be contained in the anode active material layer 1b include carbon materials such as vapor-grown carbon fiber, acetylene black (AB), Ketjen black (KB), carbon nanotube (CNT), and carbon nanofiber (CNF), and metal materials that can endure the use environment of the all-solid-state battery.

When the anode active material layer 1b is produced with an anode composition in a slurry form adjusted by dispersion of the above-described anode active material and the like in a liquid, examples of the liquid to disperse the anode active material and the like include heptane, and a non-polar solvent may be used. The thickness of the anode active material layer 1b may be for example in the range of from 0.1 μm to 1 mm, and may be in the range of from 1 μm to 100 μm. In addition, in order to make it easy to improve the performance of the all-solids-state battery, the anode active material layer 1b may be produced via a process of pressing. In the present disclosure, the pressure in pressing the anode active material layer 1b may be no less than 200 MPa, and may be approximately 400 MPa.

For the solid electrolyte to be contained in the solid electrolyte layer 2, a solid electrolyte that can be used for all-solid-state batteries may be adequately used. Examples of such a solid electrolyte include the above-described solid electrolytes that can be contained in the anode active material layer 1b. The solid electrolyte layer 2 also may include a binder to bond the solid electrolytes to each other, in view of expressing plasticity and the like. Examples of such a binder include the above-described binders that can be contained in the anode active material layer 1b. However, in view of making it possible to form the solid electrolyte layer 2 including the solid electrolyte not excessively gathered but uniformly dispersed for easily obtaining high output, the amount of the binder contained in the solid electrolyte layer 2 may be no more than 5 mass %. In addition, when the solid electrolyte layer 2 is produced via a process of applying a solid electrolyte composition in a slurry form adjusted by dispersion of the above-described solid electrolyte and the like in a liquid, examples of the liquid to disperse the solid electrolyte and the like include heptane, and a non-polar solvent may be used. The content of the solid electrolyte material in the solid electrolyte layer 2 may be for example no less than 60%, may be no less than 70%, and may be no less than 80%, by mass. The thickness of the solid electrolyte layer 2 widely differs depending on the structure of the all-solid-state battery. The thickness of the solid electrolyte layer 2 may be for example in the range of from 0.1 μm to 1 mm, and may be in the range of from 1 μm to 100 μm.

For the cathode active material to be contained in the cathode active material layer 3b, a cathode active material that can be used for all-solid-state batteries may be adequately used. Examples of such a cathode active material include layered active materials such as lithium cobalt oxide (LiCoO₂) and lithium nickel oxide (LiNiO₂), olivine type active materials such as olivine type lithium iron phosphate (LiFePO₄) and spinel type active materials such as spinel type lithium manganese oxide (LiMn₂O₄). The shape of the cathode active material may be in a particle form and a thin film form for example. The content of the cathode active material in the cathode active material layer 3b is not particularly limited, and may be in the range of 40% to 99% by mass for example.

When a sulfide solid electrolyte is used as the solid electrolyte, the cathode active material may be coated with an ion conductive oxide, in view of easy prevention of the increase in the battery resistance by making it difficult to form a high resistance layer at the interface between the cathode active material and the solid electrolyte. Examples of the lithium ion conductive oxide to coat the cathode active material include an oxide represented by the general formula LiₓAO_{y} (A is B, C, Al, Si, P, S, Ti, Zr, Nb, Mo, Ta or W, x and y are each a positive number). More specific examples may include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄ and Li₂WO₄. The lithium ion conductive oxide may be a composite oxide. As the composite oxide to coat the cathode active material, any combinations of the above-described lithium ion conductive oxides may be used, for example Li₄SiO₄—Li₃BO₃, Li₄SiO₄—Li₃PO₄ and the like may be given. When the surface of the cathode active material is coated with an ion conductive oxide, the ion conductive oxide only have to coat at least part of the cathode active material, and may coat the whole surface of the cathode active material. The thickness of the ion conductive oxide that coats the cathode active material may be in the range of from 0.1 nm to 100 nm for example, and may be in the range of from 1 nm to 20 nm. The thickness of the ion conductive oxide may be measured for example by means of a transmission electron microscope (TEM) and the like.

The cathode active material layer 3b may be produced with a binder and a conductive material that can be contained in cathode active material layers of all-solid-state batteries. Examples of such a binder and the conductive material include the above binder and the conductive materials that can be contained in the anode active material layer 1b.

When the cathode active material layer 3b is produced with a cathode composition in a slurry form adjusted by dispersion of the above-described cathode active material, solid electrolyte, binder and the like in a liquid, examples of the liquid that can be used include heptane, and a non-polar solvent may be used. The thickness of the cathode active material layer 3b may be in the range of from 0.1 μm to 1 mm for example, and may be in the range of from 1 μm to 100 μm. In order to make it easy to improve the performance of the all-solid-state battery, the cathode active material layer 3b may be produced via a process of pressing. In the present disclosure, the pressure in pressing the cathode active material layer may be approximately 100 MPa.

For the conductive material to be contained in the cathode current collector 3a′ that is a PTC film, a conductive material that can endure the use environment of the all-solid-state battery and can be used for a PTC element may be adequately used. Examples of such a conductive material include carbon black represented by acetylene black, and graphite. For the resin to be contained in the cathode current collector 3a′ that is a PTC film, a resin that can endure the use environment of the all-solid-state battery and can be used for a PTC element may be adequately used. Examples of such a resin include crystalline thermoplastic polyolefin resin such as polyvinylidene fluoride (PVDF), polyethylene (PE) and polypropylene (PP). Among them, in view of easily obtaining both the performance and safety of the all-solid-state battery, polypropylene (PP) and polyvinylidene fluoride (PVDF) that are resins that get soft at a temperature of no less than 150° C. may be used. It is noted that, in the above explanation, a configuration in which the second current collector is a conductive layer containing a conductive material and a resin is shown as an example, but the present disclosure is not limited to this configuration. When the second current collector includes a conductive layer containing a conductive material and a resin, the second current collector may have a multi-layer structure including a metal layer and the conductive layer containing a conductive material and a resin, and may be in a configuration in which a conductive or non-conductive porous body is immersed in a conductive material and a resin.

For the insulation material 3ax used for the cathode current collector 3ai, an insulation material that can endure the use environment of the all-solid-state battery may be adequately used. Examples of such an insulation material include thermoplastic resins such as polypropylene (PP), polyvinylidene chloride (PVDC), polyvinylidene fluoride (PVDF), polycarbonate (PC) and polyetherimide (PEI), rubbers such as acrylonitrile butadiene rubber (ABR) and butadiene rubber (BR), non-conductive binders such as epoxy and acrylic binder. When the insulation material is a non-conductive adhesive tape, a non-conductive adhesive tapes such as polyimide tape may be adequately used.

In the above explanation, a configuration in which the first current collector is an anode current collector and the second current collector is a cathode current collector is shown as an example. However, the present disclosure is not limited to this configuration. In the present disclosure, the first current collector may be a cathode current collector and the second current collector may be an anode current collector, and the first active material layer may be a cathode active material layer and the second active material layer may be an anode active material layer In this case, in view of easy inhibition of metal precipitation (dendrite growth), the size of the stacking face of the first active material layer (cathode active material layer) may be smaller than the size of the stacking face of the second active material layer (anode active material layer).

The all-solid-state battery manufactured by the present disclosure may have a configuration in which lithium ions transfer between the cathode active material layer and the anode active material layer, or in which ions other than lithium ion transfer. Examples of the ions other than lithium ion that can transfer between the cathode active material layer and the anode active material layer include sodium ion and potassium ion. If an all-solid-state battery in which ions other than lithium ion transfer is manufactured, the cathode active material, solid electrolyte and anode active material may be adequately chosen depending on the ion to transfer.

### DESCRIPTION OF REFERENCE NUMERALS

1 anode
1a anode current collector (first current collector)
1at tab
1b anode active material layer
2 solid electrolyte layer
3a, 3a′, 3ai cathode current collector (second current collector)
3ac central portion
3at tab
3ax insulation material
3b cathode active material layer
4, 4x, 4y stack
5, 6, 7, 8 battery element (all-solid-state battery)

1. A method for manufacturing an all-solid-state battery comprising:
forming a first active material layer on each of a right face and a reverse face of a first current collector;
forming a solid electrolyte layer on each said first active material layer formed in the forming;
arranging a second active material layer arranged on a base material, onto each said solid electrolyte layer formed in the forming, in a manner that the solid electrolyte layer and the second active material layer have contact with each other;
forming a stack by removing each said base material having contact with the second active material layer;
carrying out a roll press on the stack; and
arranging a second current collector on each said second active material layer of the stack on which the roll press is carried out.

2. The method for manufacturing an all-solid-state battery according to claim 1, wherein the roll press is a hot roll press.

3. The method for manufacturing an all-solid-state battery according to claim 2, wherein the second current collector includes a conductive layer containing a conductive material and a resin.

4. The method for manufacturing an all-solid-state battery according to any one of claims 1 to 3,
wherein:
a stacking face of the first current collector and a stacking face of the second current collector, whose normal directions are in a stacking direction of each layer of the stack, have the same shape;
in arranging the second current collector, the second current collector is arranged in a manner that the second active material layer is arranged at a central portion of the second current collector, the second current collector including an insulation material at an outer edge portion of the stacking face, the central portion being surrounded by the insulation material; and
the first current collector is an anode current collector and the second current collector is a cathode current collector.

5. The method for manufacturing an all-solid-state battery according to claim 4, wherein the insulation material is further arranged on a part of a tab extended outside from the outer edge portion of the second current collector, continuously from the outer edge portion.
